(19) United States
(12) Patent Application Publication
(10) Pub. No.: US 2024/0062311 A1
(43) Pub. Date: Feb. 22, 2024

(54) FRAUD PREVENTION ASSOCIATED WITH SERVICE MANAGEMENT OF A COMPUTING PLATFORM

(71) Applicant: INTERNATIONAL BUSINESS MACHINES CORPORATION, ARMONK, NY (US)

(72) Inventors: Utpal Mangla, Toronto (CA); Dinesh C. Verma, New Castle, NY (US); SATISH SADAGOPAN, Leawood, KS (US); MUDHAKAR SRIVATSA, White Plains, NY (US); Mathews Thomas, Flower Mound, TX (US)

(21) Appl. No.: 17/820,945

(22) Filed: Aug. 19, 2022

(51) Int. Cl. G06Q 40/00; G06F 21/64; G06F 21/55

(52) U.S. Cl. CPC G06Q 40/12; G06F 21/64; G06F 21/55; G06F 2221/034

(57) ABSTRACT

A method, computer system, and a computer program product managing data usage integrity is provided. In one embodiment, the method comprises receiving data connected with data usage of at least one user in a computer environment. The pricing information is then for the user relating to the data usage. The computer embodiment is segmented into a plurality of segment areas and a payment price is calculated for each segment area. An anomaly is detected by comparing the data usage and the associated pricing for each of segmented areas according to a preselected value. If an anomaly is selected, an end-to-end simulation check is performed for the computer environment to ascertain whether the payment price for the segment may be inconsistent with a resource usage affecting an end-to-end flow for the computer environment.

### BACKGROUND

The present invention relates generally to the field of computer management and more particularly to techniques for preventing billing fraud associated with providing a service as managed by a computing platform environment.

With the advent of technology, computer platforms can provide different services to many customers concurrently. Large data centers, cloud centric distributed systems and edge environments provide many varied services to their customers. The customers of these services are not the owner of many of these applications and therefore they are being charged for the usage of data and the services.

There are different charging models associated with data usage. Other charges may depend on the application and type of services are being provided and even the infrastructure that is being used. There are different charging models for resource utilization in the cloud, using an edge environment or the like. Determining the appropriate charging mechanism can be complicated given the plethora of nodes and applications that can run on them. This complexity becomes more challenging when a secure environment needs to be provided that is not susceptible to fraudulent billing attacks and even inadvertent errors.

### SUMMARY

Embodiments of the present invention disclose a method, computer system, and a computer program product for data management. In one embodiment, the method comprises receiving data connected with data usage of at least one user in a computer environment. The pricing information is then for the user relating to the data usage. The computer embodiment is segmented into a plurality of segment areas and a payment price is calculated for each segment area. An anomaly is detected by comparing the data usage and the associated pricing for each of segmented areas according to a preselected value. If an anomaly is selected, an end-to-end simulation check is performed for the computer environment to ascertain whether the payment price for the segment may be inconsistent with a resource usage affecting an end-to-end flow for the computer environment.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for providing billing fraud prevention according to one embodiment; and

FIG. 3 provides a block diagram of a billing fraud protection environment according to one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

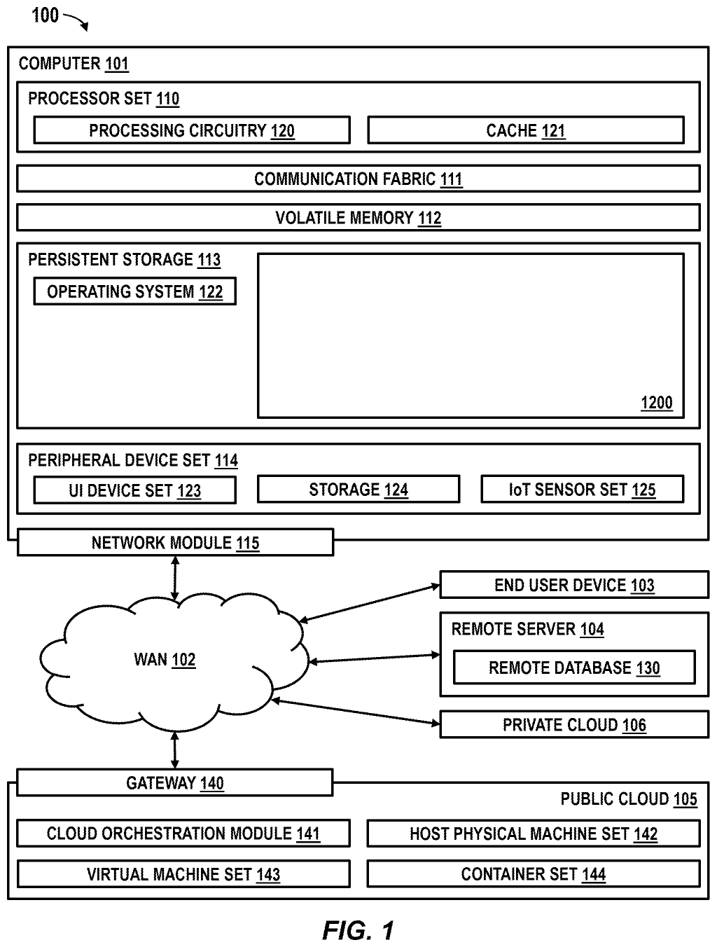

FIG. 1 provides a block diagram of a computing environment 100. The computing environment 100 contains an example of an environment for the execution of at least some of the computer code involved in performing the inventive methods, such as code change differentiator which is capable of providing a fraud protection mechanism (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As discussed earlier, there are different charging models for resource utilization using different computing infrastructure and platforms. Data centers, the cloud, network edge environments (multiaccess edge—MEC, far edge and various other nodes etc.) can all incorporate services with associated management and charges. Determining the appropriate charging mechanism can be complicated especially while providing a secure environment. Fraud prevention may be also important. These complexities also make it easier to incorrectly compute the costs and may be susceptible to fraud. For example, many of the applications running on the edge nodes will be third party applications managed by multiple parties and the owner of the system will be greatly dependent on these parties to provide the right information.

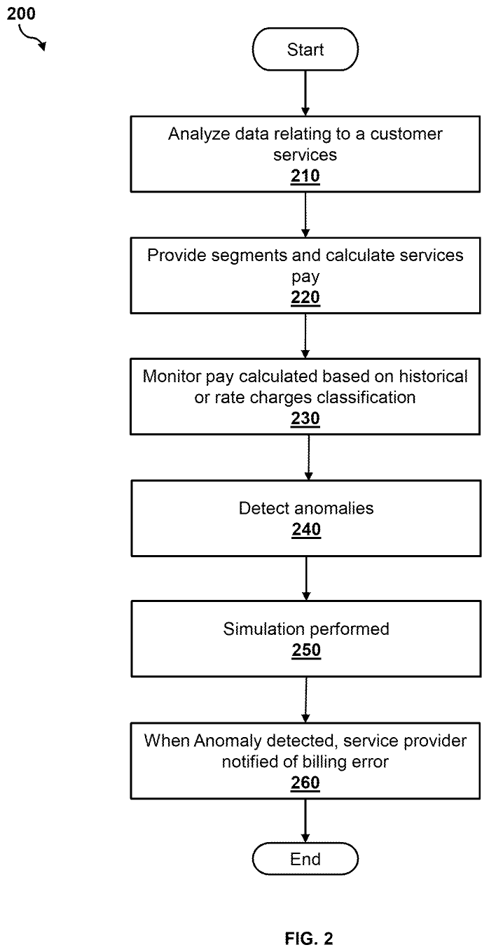

According to one embodiment a solution for capturing the charges may be provided while providing data protection. This solution as discussed in conjunction with one embodiment as provided in FIG. 2 ensures that there may be no billing fraud in these charges.

FIG. 2 provides a flowchart depiction of a process 200 that can provide data management and fraud protection in a computer environment. Step 200 is triggered when the charges (bill) from the various segmented service providers are sent. Several different computing platforms and computer environments can be used. Due the recent popularity of edge computing, scenarios are provided herein that use that environment. Edge computing is a distributed information technology (IT) architecture that enables providing such services. It is a form of computing that is done on site or near a particular data source to minimize the need for data to be processed in a remote data center. Edge computing has been used recently to provide services that are better provided when there is a need and reduced latency. Edge computing also eliminates the need to move data from endpoints such as to the cloud and back again. The scenarios (such as provided in FIG. 2) herein that use edge (computer) environment are only used for ease of understanding. It can be appreciated by those skilled in the art that other computing environments can be used in alternate embodiments. The process 200, can be used to incorporate other similar computing platforms and infrastructures.

In Step 210, data may be sent to a pricing node to compute an amount to pay a provider for services associated with the edge environment. In one embodiment, the charges are examined form end-to-end in the process from a consumption perspective. This may be to determine what the (normal) charges are for that typical process. This includes the workloads running at the different nodes, the storage requirements, resources consumed and other factors. End-to-end process analysis includes analysis of nodes which can go on-and-offline.

In Step 220, the amount of pay may be computed. In one embodiment, the charges are broken down into segments (segment-based charging). For example, a given stream of video running for X seconds will consume Y resources at each of the different nodes from the edge to the cloud (in this scenario). This computation may be accordingly also responsive to the previous step of sending additional nodes and related application to the pricing node. In one embodiment, the amount may be broken down per component in the edge environment.

In Step 230, the computation may be monitored to see whether an anomaly (Step 240) may be detected. Charging provided by the different application providers on the edge nodes will be based on the different segments of the delivery chain. When a charge has been provided by the application provider, it may be determined as whether the segment charge may be consistent with the resource usage for the end-to-end flow.

Step 240 deals with the situations where an anomaly has been detected. When an anomaly is detected a flag will be raised and further analysis needs to be done to determine root cause for the anomaly. There may be many reasons that an anomaly may exist. For example, in calculation of the charges for the segment, the present calculated amount (as broken down per a particular segment) may be larger than a preselected amount or threshold or alternatively may well exceed previous historical amounts charged. In one embodiment, the historical amounts like data usage and previous calculated price for the segment can be retrieved from storage. The presence of these anomalies, for one customer, may indicate single fraud attempts or inadvertent errors but when the anomaly exists for more than one customer or the anomaly is persistent for a segment, more sys-temic review of the environment may need to be performed. In one embodiment, this process will be used for the full life cycle of the project from the very beginning until completion (or a shut down) to prevent any system issues.

In Step 250, an end-to end simulation may be performed. The simulation may be responsive to detecting the anomaly. In addition, performing the end-to-end simulation can also be based on determining whether results are in keeping with the amount previously calculated or historically being paid by a customer to the provider.

In one embodiment, the data usage may be associated with more than one data user and one data provider. In one embodiment, the data usage may be separated according to each provider and to each user. For example, each data usage associated with a different provider may be established as a different component and different pricing may be associated and obtained for each component. In this way when anomalies are detected, they may also indicate a bigger problem that exist amongst many users and usage providers that can indicate a fraud is being committed.

In one embodiment, simulation nodes will be deployed in the above environment where the owner of the end-to-end solution can send sporadic traffic when necessary if anomalies suddenly start appearing or to confirm the charging may be occurring correctly.

To summarize:

1) Charging may be looked at from an end-to-end perspective which may make it more difficult to commit billing fraud as all the nodes need to be infiltrated.

2) Analysis will be done on a segment basis and end-to-end combination of the different segments.

3) Similar group testing can be performed to confirm values assuming sufficient groups can be identified.
4) Simulation nodes to quickly test anomalies when they occur to determine if the pricing values may be inconsistent with what may be provided or if further investigation may be needed.

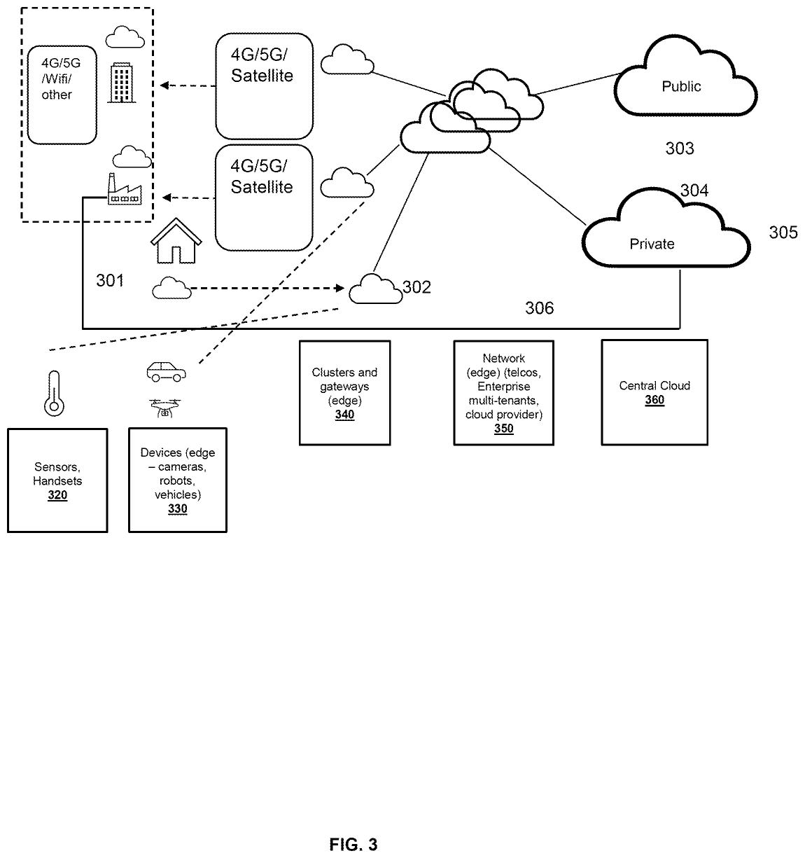

FIG. 3 provides a block diagram illustrating some of these concepts in further detail. In FIG. 3, there are a plurality of edge users and devices. The devices can be part of the edge devices illustrated as 330 and include cameras, robots and vehicles. They may also be part of a building (factory, hospital, skyscraper, house). Sensors may be incorporated into devices or be independent as shown at 320 (also may be part of appliances or have access to Internet of Things IoT). In any of these capacities, the devices may then start getting used. Once they start getting used, the appropriate data as relating to the pricing node will be provided to a processor as was provided in Step 210 of FIG. 2. This data may be appropriate for computing the price that should be paid to the provider of the services (edge).

As the devices 330 (and 320) are used they provide their data (they go through the edge, the cloud etc.). All the overall pricing for data usage (including any pricing by providers as data passes through the edge, cloud etc.) and related any charges relating to use of specific applications to complete the transaction are also sent to the pricing module (processor). In one embodiment, pricing module may then be able to compute the price for the transaction. This may be broken down for each component (and for each user or provider). For example, in the scenario of FIG. 3, some components have been illustrated as they move through the clusters and gate-ways 340, a multi-platform cloud provider 350 and a central cloud 360 that can be public or private. The different segments may be set up to be at points as illustrated by 301, 302, 303, 304, 305 and 306 in FIG. 3.

In this scenario, the price per component may be the price charged to a user (or provider) for a service. In one embodiment, an analytics module may also be tasked to looks at the computed prices and other data. The other data could include price computed for similar transactions in the past, current workloads being used at the edge node, number of users connected to the edge devices. A database (not illustrated) may be established to store different past behaviors to determine if the prices are consistent with the other data. For example, the segment 302 may indicate that the usage has been extremely elevated as compared to previous usage. This may be due to a real increase, or due to a possible error or malfunction. In either case, the situa-tion will be reviewed that may require attention. Other factors will be reviewed by the module (not illustrated) so that any anomalies can be determined as shown in FIG. 2 at 240.

Once an anomaly has been detected, as was shown in FIG. 2 at 250, a simulation module (model) will be invoked to simulate an end-to-end flow as shown through 301-306 and as discussed before. The purpose of the simulation may be to conduct and perform additional testing. This may include similar group testing, segment based testing and other tests to see if other devices and/or subscribers for example may be experiencing the same issue. If the testing results prove not to be in keeping with the expected results (product in point—301-306, for example), further investigation and analysis may have to occur to determine if an error or even possibly a fraud may be committed. In Step 260, when an anomaly has been detected, in one embodiment, a service provider may be then notified of a billing error.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing data usage integrity, comprising;
receiving data connected with data usage of at least one user in a computer environment;
obtaining pricing information for said user relating to said data usage;
segmenting said computer environment into a plurality of segment areas;
calculating a payment price for each segment area;
determining an anomaly by comparing said data usage and said associated pricing for each of said segmented areas to a preselected value; and
performing an end-to-end simulation check of said computer environment for said user when an anomaly has been detected to ascertain as whether said payment price for said segment may be inconsistent with a resource usage for affecting an end-to-end flow for said computer environment.

2. The method of claim 1, wherein said anomaly is detected by comparing said data usage to a retrieved value of a previous history of said data usage, said value being retrieved from a database.

3. The method of claim 1, wherein said anomaly is detected by comparing said pricing for said segment to a retrieved value of a previous history of said pricing, said value being retrieved from a database.

4. The method of claim 1, further comprising determining when said data usage is associated to more than one data provider and separating each data usage according to each provider, wherein each data usage associated with a different provider is established as a different component.

5. The method of claim 4, wherein different pricing is obtained for each component and said anomaly is determined for each component.

6. The method of claim 4, wherein a plurality of users exists, and any anomaly is compared between said data users to determine a common pattern.

7. The method of claim 1, wherein a plurality of users exists, and any anomaly is compared between data users nodes to determine a common pattern.

8. The method of claim 1, wherein said computer environment is an edge environment.

9. The method of claim 7, further comprising sending additional information to a data usage provider associated with said user.

10. The method of claim 8, further comprising computing an amount to pay said data usage provider of said user based on data usage and pricing information; wherein said amount to pay is broken down per segment in an edge environment.

11. The method of claim 1, wherein a final payment is calculated if no anomalies are detected.

12. The method of claim 1, wherein a final payment is calculated after an anomaly is detected but said anomaly has been resolved.

13. A computer system for data processing, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps comprising:
obtaining pricing information for said user relating to said data usage;
segmenting said computer environment into a plurality of segment areas;
calculating a payment price for each segment area;
determining an anomaly by comparing said data usage and said associated pricing for each of said segmented areas to a preselected value; and
performing an end-to-end simulation check of said computer environment for said user when an anomaly has been detected to ascertain as whether said payment price for said segment may be inconsistent with a resource usage for affecting an end-to-end flow for said computer environment.

14. The computer system of claim 13, wherein said anomaly is detected by comparing said data usage to a retrieved value of a previous history of said data usage, said value being retrieved from a database.

15. The computer system of claim 13, further comprising determining when said data usage is associated to more than one data provider and separating each data usage according to each provider, wherein each data usage associated with a different provider is established as a different component.

16. The computer system of claim 13, wherein different pricing is obtained for each component and anomalies are determined for each component.

17. The computer system of claim 13, wherein said computer environment is an edge environment.

18. The computer system of claim 14 further comprising sending additional information to a data usage provider associated with said user; and computing an amount to pay said data usage provider of said user based on data usage; wherein said amount to pay is broken down per segment in an edge environment.

19. A computer program product for data processing, comprising:
one or more computer-readable storage medium and program instructions stored on at least one of the one or more tangible storage medium, the program instructions executable by a processor, the program instructions comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps comprising:
obtaining pricing information for said user relating to said data usage;
segmenting said computer environment into a plurality of segment areas;
calculating a payment price for each segment area;
determining an anomaly by comparing said data usage and said associated pricing for each of said segmented areas to a preselected value; and
performing an end-to-end simulation check of said computer environment for said user when an anomaly has been detected to ascertain as whether said payment price for said segment may be inconsistent with a resource usage for affecting an end-to-end flow for said computer environment.

20. The computer program product of claim 19, wherein said anomaly is detected by comparing said data usage to a retrieved value of a previous history of said data usage, said value being retrieved from a database.
